(19) United States
(12) Patent Application Publication
(10) Pub. No.: US 2010/0028095 A1
(43) Pub. Date: Feb. 4, 2010

(54) Drilling Machine

(76) Inventors: Tsan-Ming Yang, Taichung City (TW); Tsan-Hsin Yang, Taichung City (TW); Shu-Sen Lin, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 12/185,808

(22) Filed: Aug. 4, 2008

(51) Int. Cl. B23B 39/00

(52) U.S. Cl. 408/99

(57) ABSTRACT

A drilling machine includes a base located on a horizontal surface, a post provided on the base, a worktable movably connected to the post and a drilling unit provided on the post. The drilling unit includes a direct-current brushless motor, a drill and a transmission. The direct-current brushless motor is provided on the post. The drill is operatively connected to the direct-current brushless motor. The transmission includes a circuit board and gear-related buttons operable to instruct the circuit board to convert an alternating current into various direct currents to cause the motor and, therefore, the drill to rotate at various rotational rates.

### FIELD OF INVENTION

The present invention relates to a drilling machine and, more particularly, to drilling machine that can be carried conveniently and shifted between gears easily.

### BACKGROUND OF INVENTION

As disclosed in U.S. Pat. No. 5,769,575, a conventional drilling machine includes a drill, a motor and a transmission through which the motor drives the drill. The transmission includes a first conical pulley connected to the motor, a second conical pulley connected to the drill and a belt wound around the first and second conical pulleys. The first conical pulley is made with a stepped form including sections of different diameters. Similarly, the second conical pulley is made with a stepped form including sections of different diameters. The first and second conical pulleys and the belt are arranged so that the belt is wound around the largest section of the first conical pulley and the smallest section of the second conical pulley or a smaller section of the first conical pulley and a larger section of the second conical pulley. The rotational rate of the drill is variable although the rotational rate of the motor is constant.

However, the transmission is complicated, bulky and heavy. It is therefore difficult to carry the conventional drilling machine. To shift gears, a heavy shell for containing the transmission is removed, and the pulley is removed from the first and second conical pulleys and wound around the first and second conical pulleys again by a skilled worker. It is therefore difficult to shift gears. The cost of the operation of the conventional drilling machine is high.

The present invention is therefore intended to obviate or at least alleviate the problems encountered in prior art.

### SUMMARY OF INVENTION

It is the primary objective of the present invention to provide a drilling machine that can be carried conveniently and shifted between gears easily.

To achieve the foregoing objective, the drilling machine includes a base located on a horizontal surface, a post provided on the base, a worktable movably connected to the post and a drilling unit provided on the post. The drilling unit includes a direct-current brushless motor, a drill and a transmission. The direct-current brushless motor is provided on the post. The drill is operatively connected to the direct-current brushless motor. The transmission includes a circuit board and gear-related buttons operable to instruct the circuit board to convert an alternating current into various direct currents to cause the motor and, therefore, the drill to rotate at various rotational rates.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a drilling machine according to the preferred embodiment of the present invention.

FIG. 2 is a cut-away view of the drilling machine shown in FIG. 1.

### DETAILED DESCRIPTION OF PREFERRED EMBODIMENT

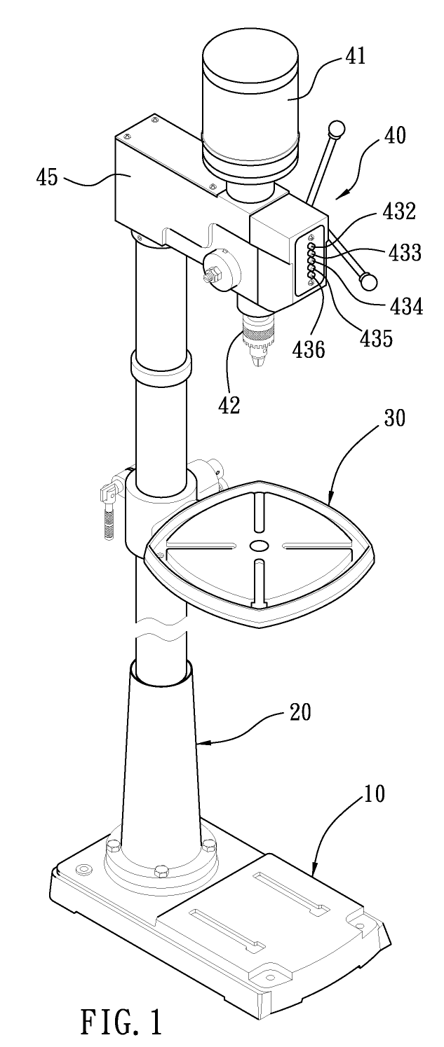

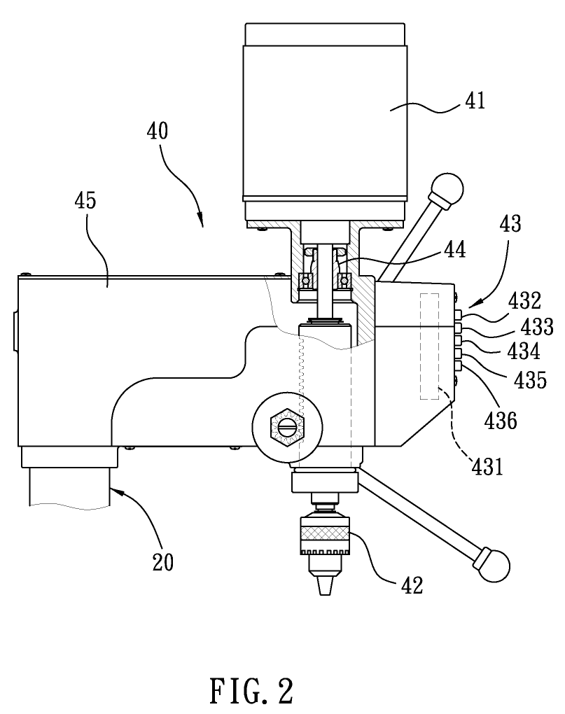

Referring to FIGS. 1 and 2, a drilling machine includes a base 10, a post 20, a worktable 30 and a drilling unit 40 according to the preferred embodiment of the present invention.

The base 10 is installed on a horizontal surface such as the ground or a floor. The post 20 is secured to the base 10. The base 10 and the post 20 are used to support the entire drilling machine.

The worktable 30 is movably connected to the post 20. A work piece can be supported on the worktable 30.

The drilling unit 40 includes a direct-current (ODCO) brushless motor 41, a drill 42, a transmission 43, a bearing set 44 and a shell 45. The shell 45 is secured to an upper end of the post 20. The DC brushless motor 41 is provided on the shell 45. The DC brushless motor 41 includes a mandrel connected to the drill 42 co-axially through the bearing set 44. The mandrel of the DC brushless motor 41 and the bearing set 44 are covered with the shell 45 so that the shell 45 protects the mandrel of the DC brushless motor 41 and the bearing set 44 from water and dust.

The transmission 43 includes a circuit board 431 and buttons 432, 433, 434, 435 and 436. The circuit board 431 is disposed in the shell 45 to provide needed controlling functions. The buttons 432 to 436 are provided on the shell 45 so that they are operable.

The button 432 is operable to turn on and off the drilling machine. The drilling machine is turned on when the button 432 is pushed. The drilling machine is turned off when the button 432 is pushed again.

The buttons 433 to 436 are operable to instruct the circuit board 431 to shift the DC brushless motor 41 and, therefore, the drill 42 between four gears. In detail, when a selective one of the buttons 433 to 436 is pushed, the circuit board 431 converts an alternating current into a specific direct current to drive the DC brushless motor 41 and, therefore, the drill 42 at a specific rotational rate.

Compared with the conventional drilling machine discussed in the BACKGROUND OF INVENTION, the drilling machine of the present invention is light and small without the pulleys and the belt and therefore can be carried conveniently. Moreover, the drilling machine of the present invention can be shifted between gears easily without having to remove the shell and disengage the belt from the pulleys and engage the belt with the pulleys again.

The present invention has been described via the detailed illustration the preferred embodiment. Those skilled in the art can derive variations from the preferred embodiment without departing from the scope of the present invention. Therefore, the preferred embodiment shall not limit the scope of the present invention defined in the claims.

1. A drilling machine comprising:
a base located on a horizontal surface;
a post provided on the base;
a worktable movably connected to the post; and
a drilling unit comprising:
a direct-current brushless motor provided on the post;
a drill operatively connected to the direct-current brushless motor; and
a transmission comprising a circuit board and gear-related buttons operable to instruct the circuit board to convert an alternating current into various direct currents to cause the motor and, therefore, the drill to rotate at various rotational rates.

2. The drilling machine according to claim 1, wherein the transmission comprises an ON/OFF button operable to turn on and off the drilling machine.

3. The drilling machine according to claim 1, wherein the drilling unit comprises a shell provided on the post for covering the circuit board, and the direct-current brushless motor is provided on the shell, and the gear-related buttons are provided on the shell.

4. The drilling machine according to claim 3, wherein the drilling unit comprises a bearing set disposed in the shell for connecting the drill to the direct-current brushless motor.
